(19) United States
(12) Patent Application Publication
(10) Pub. No.: US 2015/0188309 A1
(43) Pub. Date: Jul. 2, 2015

(54) MOTOR DRIVE CONTROL DEVICE AND MOTOR DRIVE CONTROL METHOD

(71) Applicant: SAMSUNG ELECTRO-MECHANICS CO., LTD., Suwon-Si (KR)

(72) Inventor: Soo Woong LEE, Suwon-Si (KR)

(73) Assignee: SAMSUNG ELECTRO-MECHANICS CO., LTD., Suwon-Si (KR)

(21) Appl. No.: 14/246,641

(22) Filed: Apr. 7, 2014

(30) Foreign Application Priority Data
Dec. 30, 2013 (KR) 10-2013-0166926

(51) Int. Cl. H02H 7/085

(52) U.S. Cl. CPC H02H 7/0852

(57) ABSTRACT

A motor drive control device may include: a motor drive unit generating a motor drive signal and providing the generated motor drive signal to a motor; a high temperature protection circuit unit controlling an operation of the motor drive unit depending on a change of temperature of the motor; a current adjustment unit connected between the motor drive unit and a ground terminal to thereby adjust a current flowing in the motor drive unit; and a control unit controlling the current adjustment unit depending on the change of temperature of the motor.

### CROSS-REFERENCE TO RELATED APPLICATION

This application claims the benefit of Korean Patent Application No. 10-2013-0166926 filed on Dec. 30, 2013, with the Korean Intellectual Property Office, the disclosure of which is incorporated herein by reference.

### BACKGROUND

The present disclosure relates to a motor drive control device and a motor drive control method.

In accordance with the miniaturization of a motor and the implementation of greater precision therein, various motors have been developed. For example, since a permanent magnetic synchronous motor (PMSM) has excellent performance in view of efficiency, noise, and the like, as compared to other motors, such motors have been widely used in fields requiring high degrees of motor performance.

As a control method of such a motor, a sensorless motor control method has recently been used according to requirements for the miniaturization of motors and reductions in manufacturing costs thereof. The sensorless motor control method estimates a position of a rotor within a motor using back electromotive force (BEMF) generated during operating of the motor to thereby control the motor.

In addition, in a driving circuit of the above-mentioned motor, a thermal shut down (TSD) circuit has been used to provide a protective function against high temperatures. The TSD circuit mainly uses a hysteresis function to stop driving of the motor when a temperature of the motor reaches a predetermined temperature or higher and reactivating the driving of the motor when the temperature of the motor drops to a temperature lower than the predetermined temperature.

In a motor drive control device according to the related art, when the temperature of the motor reaches a predetermined temperature or higher and driving of a motor is stopped and is then reactivated, an over-current instantaneously flows through back electromotive force of the motor, and when the temperature of the motor is increased to the predetermined temperature by the over-current, the motor may be again stopped by the TSD circuit.

That is, when a motor according to the related art is stopped by the TSD and is then reactivated, the motor may perform an abnormal operation, where the motor may be activated by the over-current instantaneously generated by back electromotive force and stopped again.

### SUMMARY

An aspect of the present disclosure may provide a motor drive control device and a motor drive control method capable of sequentially supplying current depending on a temperature of a motor to thereby prevent an over-current instantaneously generated by back electromotive force from being supplied, by using a current adjustment unit adjusting current flowing in a motor drive unit depending on the temperature of the motor and a control unit.

According to an aspect of the present disclosure, a motor drive control device may include: a motor drive unit generating a motor drive signal and providing the generated motor drive signal to a motor; a high temperature protection circuit unit controlling an operation of the motor drive unit depending on a change of temperature of the motor; a current adjustment unit connected between the motor drive unit and a ground terminal to thereby adjust a current flowing in the motor drive unit; and a control unit controlling the current adjustment unit depending on the change of temperature of the motor.

The high temperature protection circuit unit may control the motor drive unit to turn the motor on or off depending on the change of temperature of the motor.

The high temperature protection circuit unit may control the motor drive unit to turn the motor off when the temperature of the motor reaches a first temperature corresponding to a preset temperature, and control the motor drive unit to turn the motor on when the temperature of the motor drops to a second temperature lower than the first temperature.

The current adjustment unit may be a variable resistor.

The control unit may control a resistance value of the variable resistor to be increased as the temperature of the motor is increased.

The current adjustment unit may include: a resistor unit including a plurality of resistors respectively connected between the motor drive unit and the ground terminal; and a switch unit including a plurality of switches connected to the plurality of resistors.

The control unit may control the switch unit to increase a resistance value between the motor drive unit and the ground terminal as the temperature of the motor is increased.

The control unit may measure the temperature of the motor, extract a temperature section including the temperature of the motor from among a plurality of preset temperature sections, and control the switches depending on the extracted temperature section.

The control unit may extract the temperature section including the temperature of the motor by comparing a voltage value corresponding to the measured temperature with a reference voltage value for each preset temperature section.

The control unit may include: a comparison unit including a plurality of comparators comparing a voltage value corresponding to the measured temperature with a reference voltage value for each preset temperature section; and a switching control unit generating a switching control signal using a result value output from the comparison unit and outputting the generated switching control signal to the switch unit.

The motor drive unit may be a pulse width modulation (PWM) inverter providing the motor drive signal to the motor using a PWM scheme.

According to another aspect of the present disclosure, a motor drive control method may include: measuring a temperature of a motor; extracting a temperature section including the temperature of the motor from among a plurality of preset temperature sections; and adjusting a current to be provided to the motor depending on the extracted temperature section.

The extracting of the temperature section including the temperature of the motor may be performed by comparing a voltage value corresponding to the temperature of the motor with a reference voltage value for each preset temperature section.

The adjusting of the current to be provided to the motor may be performed by adjusting a resistance value between the motor and a ground.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 illustrates a configuration of a motor drive control device according to an exemplary embodiment of the present disclosure;

FIG. 2 is a graph illustrating an operation of a high temperature protection circuit unit of FIG. 1 according to an exemplary embodiment of the present disclosure;

FIG. 3 illustrates a configuration of a current adjustment unit of FIG. 1 according to an exemplary embodiment of the present disclosure;

FIG. 4 illustrates a configuration of the current adjustment unit of FIG. 3 according to an exemplary embodiment of the present disclosure;

FIG. 5 illustrates a configuration of a control unit of FIG. 1 according to an exemplary embodiment of the present disclosure;

FIG. 6 illustrates a configuration of the control unit of FIG. 1 according to another exemplary embodiment of the present disclosure; and

FIG. 7 is a flowchart illustrating a motor drive control method according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

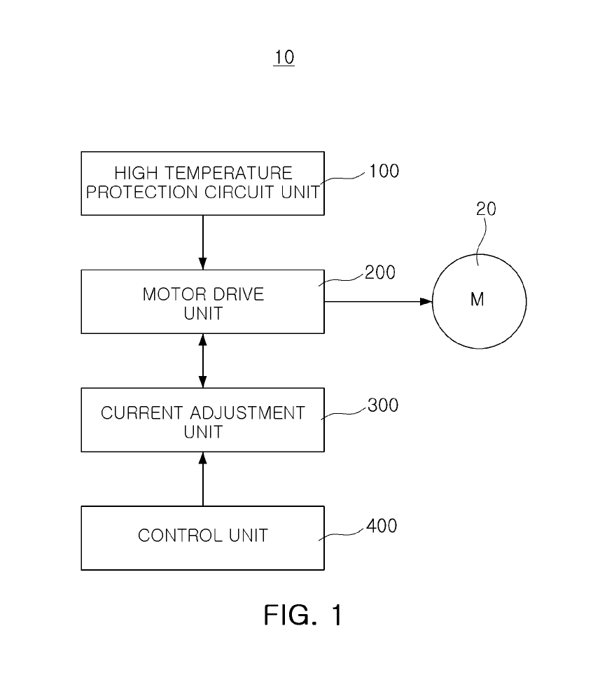

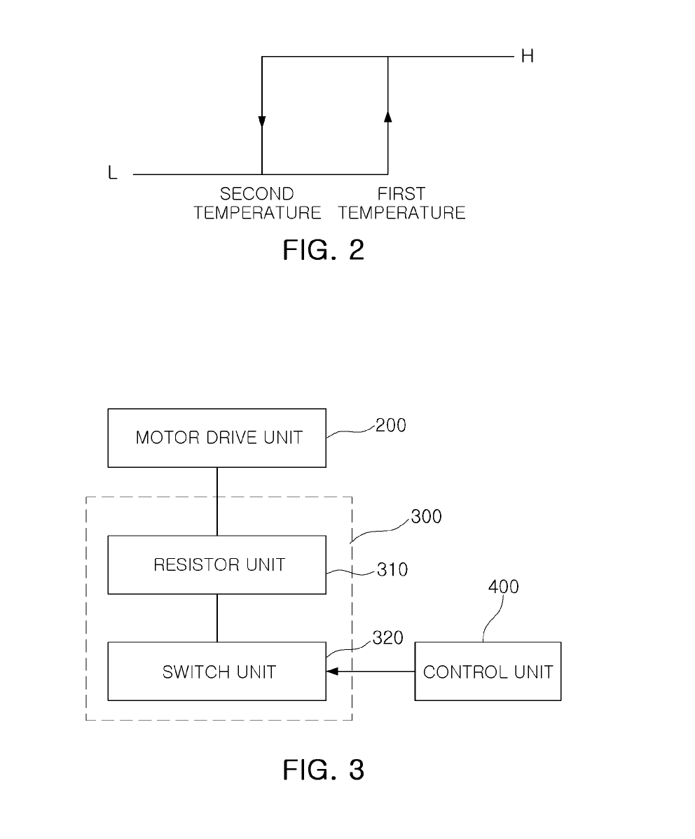

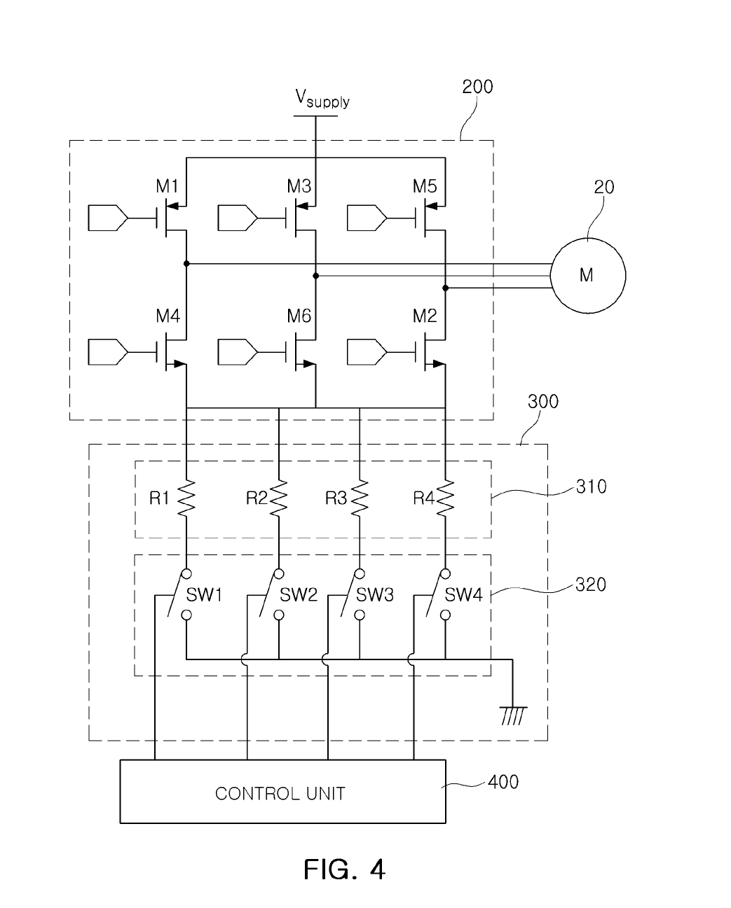

FIG. 1 illustrates a configuration of a motor drive control device according to an exemplary embodiment of the present disclosure, FIG. 2 is a graph illustrating an operation of a high temperature protection circuit unit of FIG. 1 according to an exemplary embodiment of the present disclosure, FIG. 3 illustrates a configuration of a current adjustment unit of FIG. 1 according to an exemplary embodiment of the present disclosure, and FIG. 4 illustrates a configuration of the current adjustment unit of FIG. 3 according to an exemplary embodiment of the present disclosure.

Referring to FIG. 1, a motor drive control device 10 according to an exemplary embodiment of the present disclosure may include a high temperature protection circuit unit 100, a motor drive unit 200, a current adjustment unit 300, and a control unit 400.

The high temperature protection circuit unit 100 may control an operation of the motor drive unit 200 depending on a change of temperature of a motor 20 to protect the motor 20 from high temperatures. Here, the high temperature protection circuit unit 100 may further include a temperature sensor (not shown) measuring a temperature of the motor 20 and may control the operation of the motor drive unit 200 using a temperature change amount of the motor 20 measured by the temperature sensor.

According to an exemplary embodiment of the present disclosure, the high temperature protection circuit unit 100 may control the motor drive unit to turn the motor 20 on or off depending on a change of temperature of the motor 20.

Specifically, in the case in which the temperature of the motor 20 reaches a first temperature corresponding to a preset temperature as shown in FIG. 2, the high temperature protection circuit unit 100 may control the motor drive unit 200 to turn the motor off by outputting a high signal. In addition, in the case in which the temperature of the motor 20 drops to a second temperature lower than the first temperature, the high temperature protection circuit unit 100 may control the motor drive unit 200 to turn the motor on by outputting a low signal.

For example, in the case in which the temperature of the motor 20 reaches 150° C., the high temperature protection circuit unit 100 may control the motor drive unit 200 to turn the motor 20 off in order to protect the motor 20.

The motor drive unit 200 may generate a motor drive signal and provide it to the motor 20. According to an exemplary embodiment of the present disclosure, the motor drive unit 200 may be a pulse width modulation (PWM) inverter generating a motor drive signal using a pulse width modulation scheme.

The current adjustment unit 300 may be connected between the motor drive unit 200 and a ground terminal and adjust current flowing in the motor drive unit 200. According to an exemplary embodiment of the present disclosure, the current adjustment unit 300 may be configured as a variable resistor. That is, the current adjustment unit 300 may be connected between the motor drive unit 200 and the ground terminal and adjust a resistance value to thereby adjust an amount of current flowing in the motor drive unit 200.

According to another exemplary embodiment of the present disclosure, the current adjustment unit 300 may include a resistor unit 310 and a switch unit 320 as shown in FIGS. 3 and 4.

The resistor unit 310 may be connected between the motor drive unit 200 and the ground terminal and include a plurality of resistors R1, R2, R3, and R4.

The switch unit 320 may include a plurality of switches SW1, SW2, SW3, and SW4, where the plurality of switches SW1, SW2, SW3, and SW4 may be connected to the plurality of resistors R1, R2, R3, and R4, respectively. The switch unit 320 may adjust the resistance value of the resistor unit 310 connected between the motor drive unit 200 and the ground terminal by a combination of on and off switching operations of the plurality of switches SW1, SW2, SW3, and SW4, respectively, to thereby adjust a current value flowing from the motor drive unit 200 to the motor 20. The switching operations of the plurality of switches SW1, SW2, SW3, and SW4 of the switch unit 320 may be controlled by the control unit 400.

The control unit 400 may control an operation of the current adjustment unit 300 depending on the change of temperature of the motor 20.

According to an exemplary embodiment of the present disclosure, in the case in which the current adjustment unit 300 is a variable resistor, the control unit 400 may control the resistance value of the variable resistor to be increased when the temperature of the motor 20 is increased.

According to another exemplary embodiment of the present disclosure, in the case in which the current adjustment unit 300 includes the resistor unit 310 and the switch unit 320, the control unit 400 may control the switching operation of the switch unit 320 so as to increase the resistance value of the resistor unit 310 when the temperature of the motor 20 is increased.

In addition, the control unit 400 may measure the temperature of the motor 20, extract a temperature section including the temperature of the motor 20 from among a plurality of preset temperature sections, and control the switching operation of the switch unit 320 depending on the extracted temperature section. The temperature section may be set to an appropriate range to prevent the motor 20 from being stopped again by the high temperature protection circuit unit 100 because the over-current is supplied to the motor 20 to thereby increase the temperature of the motor 20.

Here, the control unit 400 may compare a voltage value corresponding to the temperature of the motor 20 with a voltage value for each preset temperature section to thereby extract the temperature section including the temperature of the motor 20.

Specific configurations and operations of the control unit 400 will be described below in detail.

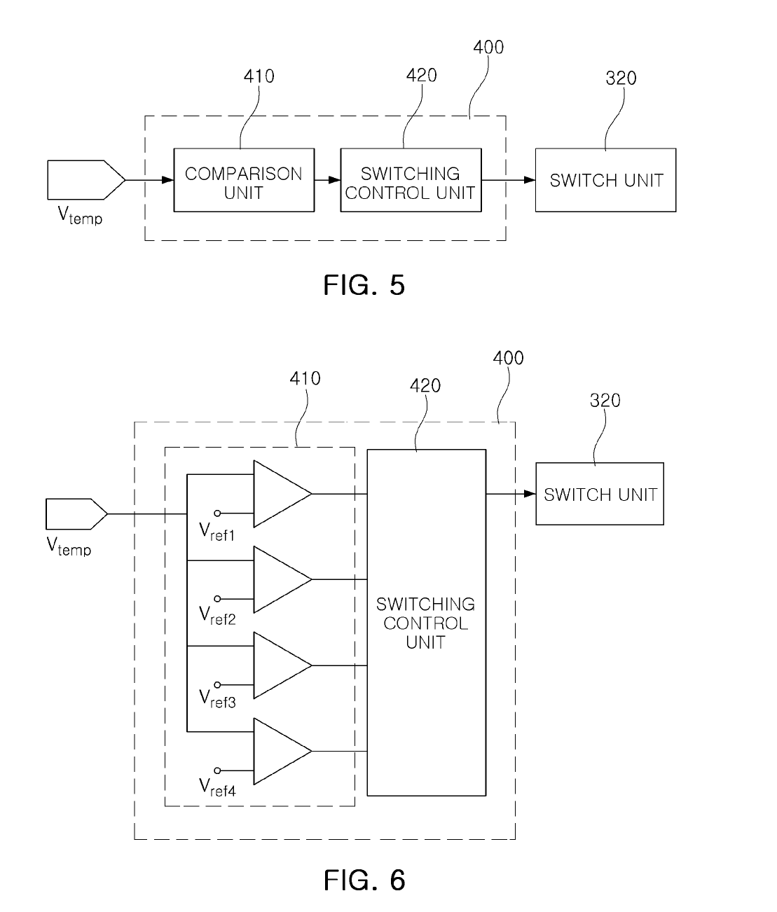

FIG. 5 illustrates a configuration of the control unit of FIG. 1 according to an exemplary embodiment of the present disclosure and FIG. 6 illustrates a configuration of the control unit of FIG. 1 according to another exemplary embodiment of the present disclosure.

Referring to FIG. 5, the control unit 400 may include a comparison unit 410 and a switching control unit 420.

The comparison unit 410 may include a plurality of comparators comparing a voltage value Vtemp corresponding to the temperature of the motor 20 with a voltage value for each preset temperature section. The plurality of comparators may compare the voltage Vtemp corresponding to the temperature of the motor 20 with respective reference voltages, output a low signal in the case in which the voltage Vtemp is higher than the reference voltages, and output a high signal in the case in which the voltage Vtemp is lower than the reference voltages.

The switching control unit 420 may generate a switching control signal using result values output from the comparison unit 410 and output the switching control signal to the switch unit 320. Here, the switching control unit 420 may generate the switching control signal in response to the high or low signal of the comparison unit 410 and provide the switching control signal to the switch unit 320.

According to an exemplary embodiment of the present disclosure, the comparison unit 410 may include a first comparator comparing the voltage Vtemp corresponding to the temperature of the motor 20 with a first reference voltage Vref1, a second comparator comparing the voltage Vtemp with a second reference voltage Vref2, a third comparator comparing the voltage Vtemp with a third reference voltage Vref3, and a fourth comparator comparing the voltage Vtemp with a fourth reference voltage Vref4. Here, the first to fourth reference voltages may have respective voltage values corresponding to first and second temperatures of the high temperature protection circuit unit 100, and any temperatures between the first and second temperatures.

For example, in the case in which the first temperature is 150° C. and the second temperature is 120° C., the first reference voltage may have a voltage value corresponding to 120° C., the second reference voltage may have a voltage value corresponding to 130° C., the third reference voltage may have a voltage value corresponding to 140° C., and the fourth reference voltage may have a voltage value corresponding to 150° C.

Here, in the case in which the temperature of the motor 20 is 135° C., the first comparator and the second comparator may output a low signal, and the third comparator and the fourth comparator may output a high signal. That is, the switching control unit 420 may extract a temperature section of 120° C. to 130° C. corresponding to ‘0011’ output from the comparison unit 410, generate a switching control signal corresponding to the extracted temperature section, and provide the generated switching control signal to the switch unit 320.

In addition, in the case in which the temperature of the motor 20 is 145° C., all of the first comparator to the third comparator may output a low signal, and the fourth comparator may output a high signal. Therefore, the switching control unit 420 may extract a temperature section of 140° C. to 150° C. corresponding to a received ‘0001’ signal and provide a switching control signal allowing the resistor unit 310 to have a resistance value corresponding to the extracted temperature section to the switch unit 320.

Here, in the case in which the temperature of the motor 20 is 145° C. rather than 135° C., that is, as the temperature of the motor becomes high, the control unit 400 may provide a switching control signal allowing a total resistance value of the resistor unit 310 to become larger to the switch unit 320, in order to decrease an amount of current provided to the motor 20.

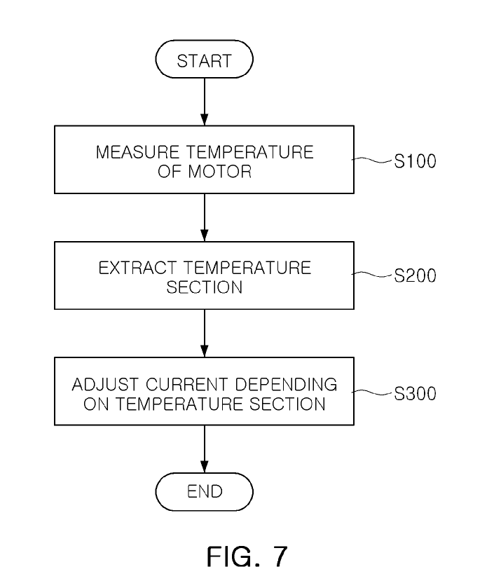

FIG. 7 is a flowchart illustrating a motor drive control method according to an exemplary embodiment of the present disclosure.

Since exemplary embodiments of the motor drive control method to be described below are performed by the motor drive control device described above with reference to FIGS. 1 through 6, overlapped descriptions of contents the same as or corresponding to the above-mentioned contents will be omitted.

Referring to FIG. 7, first, the motor drive control device 10 may measure a temperature of the motor 20 (S100).

Next, the motor drive control device 10 may extract a temperature section including the temperature of the motor 20 from among a plurality of preset temperature sections (S200).

Next, the motor drive control device 10 may adjust current provided to the motor 20 depending on the extracted temperature section (S300).

According to an exemplary embodiment of the present disclosure, in the operation of extracting the temperature section (S200), a voltage value corresponding to the temperature of the motor 20 is compared with a reference voltage value for each preset temperature section, such that the temperature section including the temperature of the motor 20 may be extracted.

According to an exemplary embodiment of the present disclosure, in the operation of adjusting the current (S300), a resistance value between the motor 20 and a ground is adjusted, such that the current provided to the motor 20 may be adjusted.

As set forth above, according to exemplary embodiments of the present disclosure, current maybe sequentially supplied depending on a temperature of a motor to thereby prevent over-current instantaneously generated by back electromotive force from being supplied, by using a current adjustment unit adjusting current flowing in a motor drive unit depending on the temperature of the motor and a control unit.

While exemplary embodiments have been shown and described above, it will be apparent to those skilled in the art that modifications and variations could be made without departing from the spirit and scope of the present disclosure as defined by the appended claims.

What is claimed is:

1. A motor drive control device, comprising:
a motor drive unit configured to generate a motor drive signal and provide the generated motor drive signal to a motor;
a high temperature protection circuit unit configured to control an operation of the motor drive unit depending on a change of temperature of the motor;
a current adjustment unit connected between the motor drive unit and a ground terminal to thereby adjust a current flowing in the motor drive unit; and
a control unit configured to control the current adjustment unit depending on the change of temperature of the motor.

2. The motor drive control device of claim 1, wherein the high temperature protection circuit unit controls the motor drive unit to turn the motor on or off depending on the change of temperature of the motor.

3. The motor drive control device of claim 1, wherein the high temperature protection circuit unit controls the motor drive unit to turn the motor off when the temperature of the motor reaches a first temperature corresponding to a preset temperature, and controls the motor drive unit to turn the motor on when the temperature of the motor drops to a second temperature lower than the first temperature.

4. The motor drive control device of claim 1, wherein the current adjustment unit is a variable resistor.

5. The motor drive control device of claim 4, wherein the control unit controls a resistance value of the variable resistor to be increased as the temperature of the motor is increased.

6. The motor drive control device of claim 1, wherein the current adjustment unit includes:
a resistor unit including a plurality of resistors respectively connected between the motor drive unit and the ground terminal; and
a switch unit including a plurality of switches connected to the plurality of resistors.

7. The motor drive control device of claim 6, wherein the control unit controls the switch unit to increase a resistance value between the motor drive unit and the ground terminal as the temperature of the motor is increased.

8. The motor drive control device of claim 6, wherein the control unit measures the temperature of the motor, extracts a temperature section including the temperature of the motor from among a plurality of preset temperature sections, and controls the switches depending on the extracted temperature section.

9. The motor drive control device of claim 8, wherein the control unit extracts the temperature section including the temperature of the motor by comparing a voltage value corresponding to the measured temperature with a reference voltage value for each preset temperature section.

10. The motor drive control device of claim 8, wherein the control unit includes:
a comparison unit including a plurality of comparators comparing a voltage value corresponding to the measured temperature with a reference voltage value for each preset temperature section; and
a switching control unit generating a switching control signal using a result value output from the comparison unit and outputting the generated switching control signal to the switch unit.

11. The motor drive control device of claim 1, wherein the motor drive unit is a pulse width modulation (PWM) inverter providing the motor drive signal to the motor using a PWM scheme.

12. A motor drive control method, comprising:
measuring a temperature of a motor;
extracting a temperature section including the temperature of the motor from among a plurality of preset temperature sections; and
adjusting a current to be provided to the motor depending on the extracted temperature section.

13. The motor drive control method of claim 12, wherein the extracting of the temperature section including the temperature of the motor is performed by comparing a voltage value corresponding to the temperature of the motor with a reference voltage value for each preset temperature section.

14. The motor drive control method of claim 12, wherein the adjusting of the current to be provided to the motor is performed by adjusting a resistance value between the motor and a ground.
